(19) United States
(12) Patent Application Publication
(10) Pub. No.: US 2005/0236011 A1
(43) Pub. Date: Oct. 27, 2005

(54) Method for tensioning dental floss in dental floss holders

(76) Inventor: Ingram S. Chodorow, San Diego, CA (US)

Correspondence Address: ABELMAN, FRAYNE &SCHWAB, 150 East 42nd Street, New York, NY, 10017-5612, US

(21) Appl. No.: 11/093,328

(22) Filed: Mar. 29, 2005

Related U.S. Application Data
(60) Provisional application No. 60/557,447, filed on Mar. 29, 2004.

(51) Int. Cl. A61C 15/00

(52) U.S. Cl. 132/327

(57) ABSTRACT

A method for removing slack from dental floss in a molded plastic dental flosser which comprises a handle and arms formed of a first plastic and a strand of dental floss extending with slack between and engaged to the arms, with opposite ends of the strand of dental floss extending outward of the arms, the strand of dental floss having a nominal breadth and formed of a lubricous second plastic which is different from and not chemically bonded to the first plastic, the method for removing slack comprising the steps: a. immobilizing the arms from moving, b. pulling the opposite ends of the strand of dental floss in opposite directions while the arms remain immobilized, such that portions of the strand of dental floss are moved axially through the arms until the slack in the dental floss extending between the arms is removed, c. heating, melting and severing the dental floss at locations immediately outward of each of the arms, thereby forming at least one coalesced bead in each of the severed ends of the dental floss, where each of the beads has nominal diameter transverse of the axis of the strand that is greater than the nominal breadth of the strand, and d. releasing the arms of the flossers from the immobilization of step a.

### BACKGROUND OF THE INVENTION

1. Field of the Invention

This invention is in the field of manufacturing dental floss holders which typically have a handle and two spaced apart arms with a strand of dental floss extended between and secured to these arms. This invention is an improvement of the injection molding process and apparatus using a multi-cavity mold where a plurality of dental floss holders are molded at once during which time the floss is molded into the handles ‘in situ’.

2. Prior Art Relating to Injection Molding of Dental Floss Holders

In a conventional method of manufacturing injection molded dental floss holders, also called dental flossers, in a multi-cavity mold a length of multi-filament Nylon dental floss is extended through the arm portions of all the aligned cavities of dental floss holders and plastic is injected into the cavities, wherein the floss in the arm portions becomes surrounded by the molten plastic and the floss is thereby molded ‘in situ’ into the arms. Prior to the actual injection of liquid plastic the floss is put into tension so that it will extend in a straight line and be taut and straight at the time of molding. After the injected plastic has cooled and hardened and the mold is open, the flossers extend side-by-side as a rack or shot with the floss extending as a continuous strand between the flossers. The strand is then cut between each two adjacent flossers, which flossers are then separated for either further processing or packaging. A conventional way of cutting the multi-filament floss between adjacent flossers is to use a flame or other heat element which burns through the floss and at the same time causes the multi-filament floss fibers to coalesce into one single bead or into a plurality of beads whose overall diameter is greater than the original diameter of the strand. This larger diameter of the bead(s) serves as an anchor to prevent the floss from pulling through the arm during use by a user.

When manufacturing a dental flosser with Nylon floss, the floss is stretched considerably as it is drawn over the face of the mold and across a plurality of cavities, each of which will produce one dental flosser. Nylon floss stretches more than 20%. The pre-molding stretching process removes about half of this elongation potential. After molding, when the plastic flossers cool, they shrink, causing the arms of the flossers to move toward each other. That shrinkage reduces some of the pre-injection tension on the floss, but not enough to eliminate its linearity. The floss between the arms when they cool and harden is thus still in a partially stretched state, and is not only straight, but still somewhat tensioned.

When customers use the flossers and subject the floss to stress, the floss stretches further, because its full capacity for elongation hasn't been used in the manufacturing process. The reason that manufacturers do not stretch the floss to its maximum potential before injection is to avoid the risk of breaking the floss. Since the Nylon floss retains some capability to further stretch, users find that the floss in use will stretch and sag, and sometimes shred and break.

In this industry it was discovered that ultra high molecular weight polyethylene (“UHMWP”) floss had certain significant advantages over Nylon floss. UHMWP floss only stretches or elongates about 3-5% as compared to the over 20% for Nylon. UHMWP floss can be subjected to considerable tensioning during the manufacturing process because this fiber is about seven times stronger than Nylon. However, even removing two thirds of its elongation potential, namely about 2%, is not enough to keep the floss perfectly straight after molding, because shrinkage of the arms causes about 3% or more in reduction of the space between the arms which is greater than the initial stretch. Therefore, virtually all flossers made with UHMWP floss have non-linear floss between the arms.

UHMWP floss is furthermore lubricous and thus slippery and easier to negotiate between tight adjacent teeth. Also this floss is very strong and tends not to break during use. Lastly, since this floss stretches so little, it will not sag like Nylon floss when subjected to normal forces during flossing.

These flossers are typically made of polypropylene plastic. At the conclusion of the injection molding stage, when these flossers cool and harden, the arms tend to shrink in towards each other, causing the floss extending between them to become slightly slack. For many users it is preferred that the floss be taut rather than slack, because it is easier to maneuver taut floss between two closely adjacent or tight teeth than slack floss which bends away rather than snaps through between the teeth.

Thus, it is an object of this invention to provide a new method of manufacture whereby the floss in each completed flosser will be taut, notwithstanding the fact that each flosser upon cooling and hardening has its arms shrink toward each other in a manner which automatically causes a slackening of the floss.

It is a further object of this invention to provide such a new method of manufacture that is applicable in injection molding with a multi-cavity mold, where a plurality of flossers are made at once, typically as a shot or rack of ten flossers.

It is a still further object of this invention to provide this new method of manufacture to achieve taut floss in the injection molded dental floss holders, while still using existing multi-cavity molds which are quite expensive and represent a substantial capital investment and asset.

### SUMMARY OF THE INVENTION

This invention is a method which proceeds from a known method of manufacturing dental floss holders in a multi-cavity mold as described in the prior art above where the resulting flossers have slack floss, and adds steps which remove the slack from these flossers. From a typical known multi-cavity mold is produced a shot of flossers all attached to a common runner with a continuous strand of floss still extending through the arms of all the flossers. Because of the common runner connecting all the flossers in a multi-cavity mold, all the flossers of a single shot can be lifted and moved while they remain in the same orientation and spatial relationship to each other. In this new method the “shot” of flossers aligned and in a common plane are positioned on a new fixture which includes a base and a plurality of projections which engage and maintain the flossers in their respective positions. As will be described later, it is possible to separate these flossers from each other before they are positioned on the new fixture.

As mentioned before, when these flossers cool and harden, the arms shrink slightly toward each other and the floss becomes slightly slack. In the new invention these flossers with the slack floss, are placed upon the a new fixture having projections which immobilize the flosser arms in their relaxed state which is shrunk slightly toward each other, with slack floss between each pair of arms. Then the opposite ends of the single common strand of floss extending through the plurality of joined floss holders, are pulled in opposite directions. Because the floss is lubricous and of a plastic different from that of the floss holder or handle, there is no chemical bonding between the floss and the holder, and furthermore there is little or no mechanical bonding. While the arms are immobilized by the fixture, the floss is pulled in opposite directions, which causes portions of this floss to be displaced axially through the arms until the slack is removed from the floss extending between each pair of arms, and also in the areas between adjacent flossers.

The next step is application of the heat via a flame or hot element to the floss between each two arms of adjacent floss holders, in a manner as previously described, which cuts through the floss and simultaneously causes the multi-filament floss to coalesce into at least one bead of diameter greater than the original diameter or breadth of the floss. Because of these beads which serve as anchors, the floss cannot pull through the arms, since the diameter of each bead is greater in diameter or breadth than that of the hole through the arm which is essentially the same as the diameter of the original strand of floss.

Since the flosser arms were shrunk inward toward each other prior to the burning of the floss, they will continue to be in that relaxed state after the floss is pulled taut and secured by the bead. Thus, the final flosser product will have floss that is taut and secured from pulling out of the arms.

By the new method of manufacture described above, the floss holders with taut floss will be produced while using original multi-cavity molds, injection apparatus and burning equipment. Thus, there is no sacrifice or loss of the expensive existing manufacturer apparatus, and there is merely addition of a new final stage of fixtures and procedures.

While the new method was described with respect to a single shot of a plurality of flossers in a single plane, it is feasible to stack numerous shots in planes parallel and adjacent to each other. Thus, a shot of ten aligned flossers in fifteen layers would produce one hundred-fifty flossers on a single fixture to have their floss burned and beaded and secured generally at the same time. The burning or heating elements may be operated by robotic or other automatic equipment, so that a great many flossers are positioned, immobilized at the same time, and the strands are made taut and cut and beaded at the same time.

The material favored for these flossers is polypropylene plastic for the handles and high density molecular weight polyethylene plastic for the multi-filament dental floss.

A still further embodiment of the invention utilizes the steps and apparatus generally described above, but adds an additional step. After the shot of attached flossers are positioned in a fixture and before the common strand of floss is pulled in opposite directions to cause it to be taut as it extends between all the floss holders, the added step is to provide additional elements in the fixture which engage and urge each two pairs of arms of each flosser toward each other very slightly, thus flexing them inwardly against their tendency to spring back away from each other. While the arms of these flossers are urged toward each other said slight amount, the dental floss strand is pulled at its opposite ends to slide through the arms and become taut between each two pair of arms. The next step is the burning and beading which has been previously described which also separates each flosser from the next. Finally, when these flossers are removed from the fixture, their arms are no longer urged toward each other, and will resiliently spring back away from each other, thus causing the floss between the arms to be made even more taut than from the tensioning process during the burning and cutting stage.

The floss, being made of ultra high molecular weight polyethylene plastic has the property of stretching by about 5%, which is many times less than the stretching of up to 25% that would occur with Nylon floss.

In summary, this new invention is a method and apparatus which removes slack from flossers at the time of their manufacture. The new method proceeds from a known method of manufacturing dental flossers in a multi-cavity mold as described in the prior art above where the resulting flossers have slack floss, and add steps which eliminate the slack. In the prior method a multi-cavity mold produces a shot or rack of aligned flossers, all attached to a common runner, and all sharing a continuous strand of floss that extends through all the arms of the aligned flossers. These flossers are spaced relatively close together, so that small segment of the floss extends between adjacent arms of each two adjacent flossers, and opposite ends of the strand of floss extend outwardly from the remote arms of the flossers at opposite ends of the shot. As is known, with flossers made with ultra high molecular weight floss which stretches little, when a hardened shot of flossers is removed from a mold and the arms of each of the flossers of the shot cool and harden, they shrink inward toward each other a small distance causing the floss between each set of arms to develop slack and typically become non-linear. Since some users prefer flossers without slack, an objective of this invention is to remove the slack by any of the three embodiments of the present invention disclosed herein. This new method pertains to flossers made of ultra high molecular weight floss or equivalent molded into the arms of polypropylene or equivalent plastic, where the floss is not chemically bounded to the plastic of the arms, and furthermore, there is little or no mechanical bonding because the floss is so lubricous.

Three different embodiments of the new invention are disclosed herein, as follows.

Method I:

The flossers with slack floss are positioned on a fixture where they are aligned as they were in the multi-cavity mold, with the flossers all oriented the same so that the strands of floss are aligned coaxially. A typical shot contains ten aligned flossers which may be positioned on the new fixture while they remain attached to the common runner joining the flossers or they may be separated from each other when positioned on the fixture.

In either case, whether the flossers remain joined to a runner or separated, the flossers are immobilized on the fixture, so that the arms cannot move in the direction of the axis of the floss through the arms or in a direction transverse of said axial direction or in a direction perpendicular to the plane of the flosser which is generally flat.

With the arms so immobilized from moving in any direction, the floss extends as a continuous strand through all the arms of the aligned flossers and the opposite ends of the floss are engaged and pulled in opposite directions. In each of the flosser arms the floss of a nominal diameter extends through a hole in the arm of essentially the same diameter, since the arm was molded onto and about the floss. During the above-mentioned pulling stage the floss is pulled through the immobilized arms until the slack is removed and the floss is relatively taut. The next and final stage is cutting and burning or melting the segment of floss extending between adjacent arms of each two adjacent flossers and the floss extending out of the remote arms of each of the two outermost flossers. In the preferred embodiment a flame is directed to each segment of floss being cut. The flame not only severs the floss, but also causes the fibers of this multi-filament floss to melt and coalesce into one or multiple beads whose combined diameter is greater than that of the original strand. The bead or heads function as a head or button that prevents the floss from subsequently being pulled through the arm of the flosser during use when extreme force may be applied to the floss extending between the arms.

Method II

In a second embodiment of the present invention, flossers from a typical multi-cavity mold are separated and positioned and immobilized on a fixture, with the common strand of floss extending generally axially through all the arms of the aligned flossers, these flossers still having slack in the floss between the pair of arms of each flosser.

The two opposite ends of the strand of floss extending contiguously through all the arms, is extended generally axially and engaged securely from further axial movement, with the floss between each pair of arms of each flosser still slack from the prior cooling stage. Next, the segment of floss between each two adjacent arms of each two adjacent flossers is engaged and pushed in a direction transverse to the axis of the floss, until this floss is pulled axially through the arms of the flosser and the slack is removed. The floss segments extending out of the outside edges of the outermost flossers are similarly pushed. To achieve this pushing an elongated member with a plurality of pusher elements is moved perpendicularly of the floss axis, so that all the elements contact and push the floss at once. Finally, the cutting and melting stage is done as previously described, where a flame is directed to the floss just outward of each arm until the floss is cut and melted and coalesced into the one or more beads.

Method III

In a third embodiment of the present invention, flossers from a typical multi-cavity mold are separated and positioned and immobilized on a fixture, with the common strand of floss extending generally axially through all the arms of the aligned flossers, these flossers still having slack in the floss between the pair of arms of each flosser.

Next, the arms of each of the flossers are urge slightly toward each other which causes still greater slack in the floss between each pair of arms; however, the two opposite ends of the strand of floss extending contiguously through all the arms, are then extended generally axially and engaged.

Next, while the arms of each flosser are releasably held in the flexed state of being pressed toward each other, the engaged ends of the floss are pulled in opposite directions until the floss moves axially through the arms and the slack in all the flossers is removed. Alternatively, the slack could be removed by the method of Method II described above, where the opposite ends of the floss are fixed axially and pusher elements are pressed against the floss segments between respective flossers.

Finally, there is cutting and melting by the set of flames directed to the floss extending outside the outer edge of each arm, where the floss is cut, melted and coalesced into the beads.

In any of these methods the number of flossers placed on the immobilizing fixture may vary, the preferred arrangement being an alignment of ten which are stacked fifteen high, so that one hundred fifty flossers at once have the slack removed. By subsequent techniques known in the industry, these flossers are transferred to other fixtures or apparatus for high speed examination and/or packaging.

The foregoing and other objects of this invention, the various features thereof, as well as the invention itself may be more fully understood from the following description when read together with the accompanying drawings.

### BRIEF DESCRIPTION OF THE DRAWINGS

FIG. 1 is a schematic top plan view of a typical shot of injection molded dental flossers with a common runner and a single strand of dental floss extending through the arms of all the flossers,

FIG. 2 is a schematic top plan view of a fixture assembly for use according to a first embodiment of the new method of manufacture of the present invention, in which a shot of dental flossers is positioned and immobilized,

FIG. 3 is a schematic top plan view of the fixture assembly with flossers of FIG. 2 with a flame-type cutting and melting device,

FIGS. 4 and 5 shows schematically top plan views of a fixture assembly for use according to a second embodiment of the new method of manufacture of the present invention, on which flossers are immobilized and a pressure member pushes against segments of the floss to remove slack between respective arms of the flossers,

FIG. 6 shows schematically a top plan view of a fixture assembly according to a third embodiment of the new method of manufacture of the present invention, on which flossers are immobilized and slack is removed from floss extending between the arms of respective flossers, and

FIG. 7 shows a top front perspective view of a partially loaded fixture for holding and immobilizing a large plurality of flossers adapted to have slack removed from the floss extending between the pair of arms of each flosser.

### DETAILED DESCRIPTION OF THE PREFERRED EMBODIMENTS

The three embodiments in the form of three methods of manufacture of the present invention are shown in FIGS. 2 and 3, FIGS. 4 and 5, and FIG. 6 respectively.

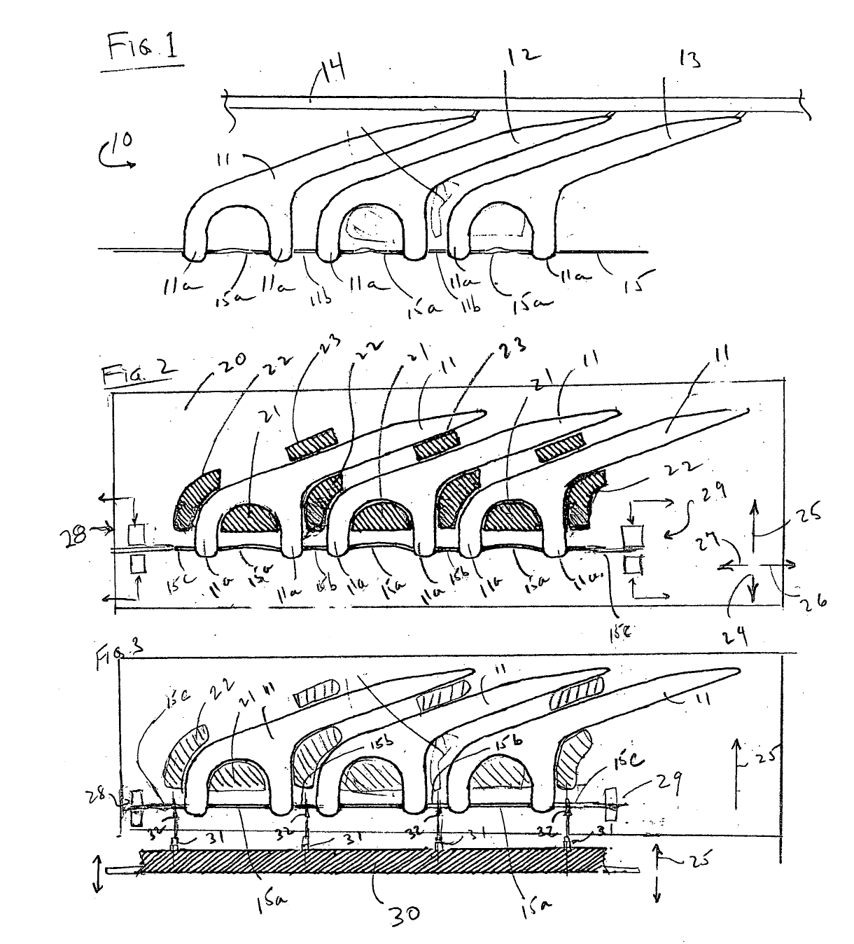

FIG. 1 shows a portion of a shot of injection molded flossers from a prior art method of manufacture which is the starting point for each of the three new methods. In FIG. 1 the shot 10 includes three injected molded flossers 11, 12 and 13 which are attached to a common runner 14. A single contiguous strand of dental floss 15 extends generally axially through the arms 11a of the flossers. As further seen in FIG. 1 the floss 15 is slack and slightly non-linear in the segments 15a of floss between each two pair of arms 11a, this slack having been described earlier herein as the inherent result of the arms of each flosser shrinking inwardly toward each other at the time of cooling and hardening of the shot immediately following injection.

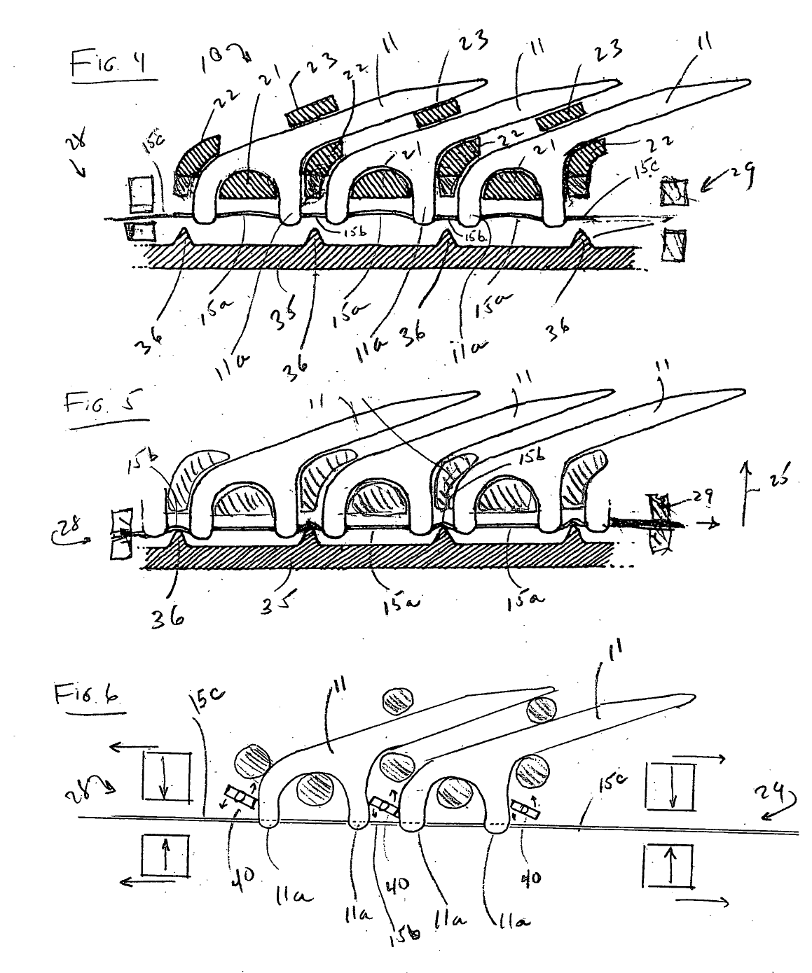

The first embodiment, Method I of the present invention for removing the slack in new flossers seen in FIG. 1, is disclosed in FIGS. 2 and 3, where the flossers 11 with slack are situated on an immobilized fixture 20. Positioning elements 21, 22 and 23 bar the flossers 11 from moving forward in the direction indicated by arrow 24, rearward in the direction of arrow 25 or laterally in the direction of arrows 26 and 27. Also, all these elements have a height dimension not shown (out of the plane of the paper), whereby each element is an upward extending post, and between these various posts one can stack layers of flossers. In a preferred embodiment ten flossers are aligned in a plane, and flossers are stacked in fifteen layers for a total of one hundred and fifty flossers at once to have the slack removed. The flossers seen in FIG. 2 have been separated from their common runner and thus from each other; however, they could optionally remain attached to the runner when placed on the immobilizing fixture. A fixture for holding five hundred flossers at once is illustrated in FIG. 7 and described later.

The positioning elements 21 and 22 not only bar movement of the flossers in the forward and rearward directions, but they effectively bar the arms 11a from bending or moving transversely in the directions of arrows 26 and 27 when the floss is pulled through these arms, as discussed below.

FIG. 2 further shows that at this initial stage the floss 15a is slack between each pair of arms 11a of each flosser 11, the floss 11b is generally straight between each two adjacent flossers, and the floss ends 11c extend generally axially in opposite directions to floss-clamping means 28 and 29 respectively. According to this First Method I, after the flossers are situated on the fixture and secured in place, the floss ends 11c of each layer of flossers having slack removed, are engaged by the floss clamping means 28, 29 and pulled in said opposite directions while all the flosser arms 11a are barred from moving in said transverse or other directions. This pulling phase pulls the floss through the flosser' arms until all the slack is removed as seen in the flossers of FIG. 3.

Next, as seen in FIG. 3, arm 30 including flame nozzles 31 is moved rearwardly, in the direction of arrow 25 until the flames 32 burn through segments 11d of floss between flossers and through floss end segments 11c. Simultaneously with cutting, the burning melts the cut ends of floss into coalesced beads, where the multi-filament floss forms at least one large or multiple smaller beads whose combined diameter is greater than the diameter of the original strand of floss and thus greater than the diameter of the hole in the arm through which the floss extends. Finally, the flossers now with the slack removed and the floss ends fixed in the arms, are removed and directed to subsequent final stages for finishing and packaging.

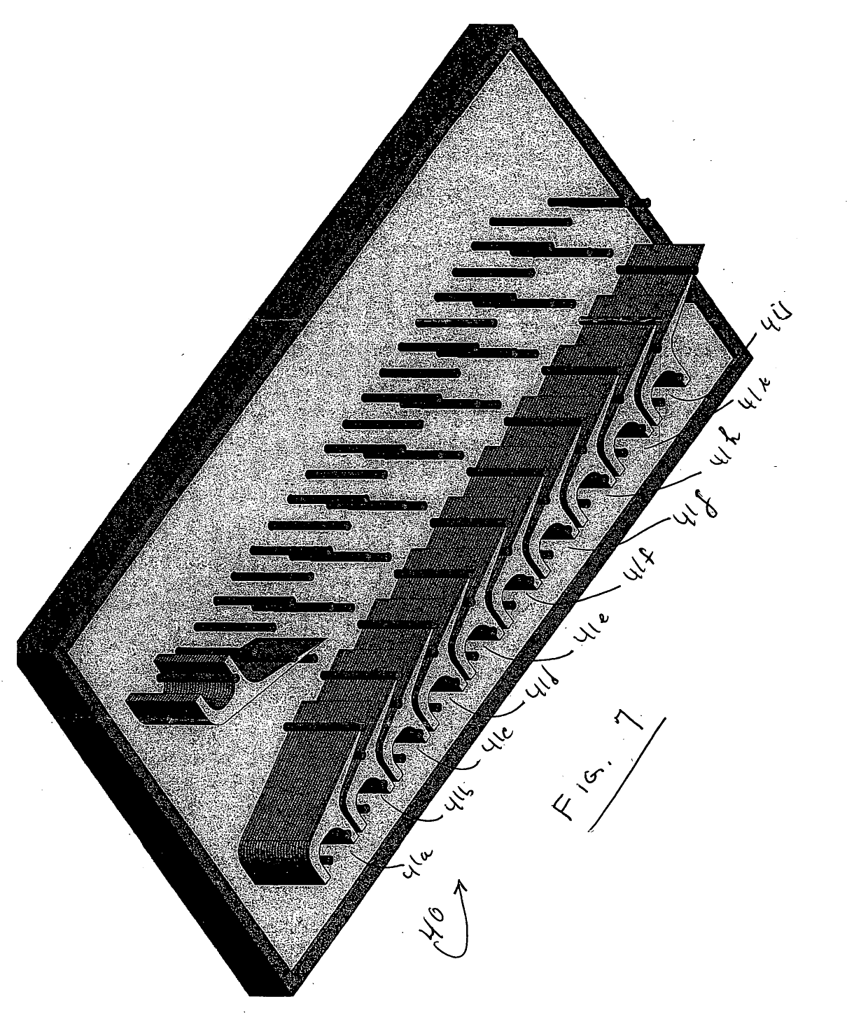

Method II of manufacture, as seen in FIGS. 4 and 5, achieves the same general results with a somewhat varied method of reducing slack. FIG. 4 shows the flossers 11 with slack 15a positioned on an immobilizing fixture 10 with positioning elements 21, 22 and 23 barring the flossers 11 from movement. Next, the floss ends 11c are extended in opposite directions to be generally axial, and are fixed by floss-engaging means 28, 29 which bar further axial movement of this floss. Next, bar 35 with pusher elements 36, as seen in FIG. 4, is moved in the rearward direction of arrow 25, as seen in FIG. 5, until pusher elements 36 engage and push floss segments 15a. Since the floss ends 11c are fixed by means 28, 29, and since the flosser arms 11a are fixed in the fixture, the pushers 36 engaging the floss only in between adjacent flossers, causes the floss to slide through the arms of flossers until the slack 15a is removed. Next, and as a final step, the cutting and beading step described above in connection with FIG. 3 is repeated. This second method differs from the first method in a number of ways, and particularly in that slack is removed from each flosser independently of slack removal in other flossers. Method I, in contrast, pulls the floss by engaging only the opposite ends 11c; with this procedure certain different degrees of stretching may occur at different positions along the length of the strand. In Method II, the stretching of the sequential segments is more uniform.

Method III is shown by FIG. 6 where the flosser arms are urged slightly toward each other before the slack is removed. More specifically, the flossers with slack are secured on immobilizing fixture 10, among positioning elements 21, 22 and 23 which bar subsequent movement in the rearward, forward or sideward directions. This fixture has additional floss tensioning elements 40 which when partially rotated in a counter clockwise direction, engage and urge the arms of each of the flossers toward each other. This causes the slack between each pair of flosser arms to be greater; however, while the arms are temporarily maintained in this flexed state (toward each other) floss end engaging means 28, 29 engage and pull the floss ends 11c until the floss slides axially through all the flosser arms, as done in FIG. 2. Then, while the arms are still flexed, a flame cutter 30, 31, 32 (as seen in FIG. 3) cuts the floss segments between flossers and forms said coalesced beads in the ends of the floss. Other means may be selected for temporarily urging the flosser arms toward each other before the slack is removed. In all techniques, the arms will resiliently spring back to their unflexed state, thus imparting still greater tautness to the floss between the arms. Optionally, the slack may be removed by the pusher mechanism seen in FIGS. 4 and 5.

Each of the three methods described above may be conducted on a high volume basis as indicated schematically in FIG. 7. This figure shows a fixture 40 adapted to hold an array of ten piles (41a-41j) of flossers seen at the lower half of fixture 40 and an array of ten additional piles of flossers (not shown) at the upper half of fixture 40. Each pile seen in the lower array holds twenty-five flossers, and thus the lower array holds a total of two hundred fifty flossers, while the upper array can be loaded to hold an additional two hundred and fifty. Not shown are clamping elements and other components known in the fixture art for positioning, holding and releasing such a plurality of products. Also not shown in FIG. 7 are the additional structures shown and discussed for conducting each of said three methods. Obviously, the number of piles and the number of flossers in each pile may be varied as desired. As indicated above, a fixture as seen in FIG. 7 or an equivalent fixture can be adapted for use with any of the three methods described herein.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A method for removing slack from dental floss in a molded plastic dental flosser which comprises a handle and arms formed of a first plastic and a strand of dental floss extending with slack between and engaged to said arms, with opposite ends of said strand of dental floss extending outward of said arms, said strand of dental floss having a nominal breadth and formed of a lubricous second plastic which is different from and not chemically bonded to said first plastic,
said method for removing slack comprising the steps:
a. immobilizing said arms of said dental flosser from moving,
b. pulling said opposite ends of said strand of dental floss in opposite directions while said arms remain immobilized, such that portions of said strand of dental floss are moved axially through said arms until said slack in said dental floss extending between said arms is removed,
c. heating, melting and severing said dental floss at locations immediately outward of each of said arms, thereby forming at least one coalesced bead in each of said severed ends of said dental floss, where each of said beads has nominal diameter transverse of the axis of said strand that is greater than said nominal breadth of said strand, and
d. releasing said arms of said flossers from said immobilization of step a.

2. A method for removing slack from dental floss in a plurality molded plastic dental flossers, where each flosser comprises a handle and arms formed of a first plastic and a strand of dental floss extending with slack between and engaged to said arms, with opposite ends of said strand of dental floss extending outward of said arms, said strand of dental floss having a nominal breadth and formed of a lubricous second plastic which is different from and not chemically bonded to said first plastic, and where said strand of dental floss extends contiguously through the arms of said plurality of dental flossers,
said method for removing slack comprising the steps:
a. positioning and aligning said plurality of dental flossers on a immobilizing fixture with said dental flossers oriented similarly and spaced apart such that said contiguous strand of dental floss is generally coaxial as it extends through the arms of said dental flossers,
b. immobilizing said arms of said dental flossers from moving,
c. pulling said opposite ends of said strand of dental floss in opposite directions while said arms remain immobilized, such that portions of said strand of dental floss are moved axially through said arms of said dental flossers until said slack in said dental floss extending between said arms in said dental flossers respectively is removed,
d. heating, melting and severing said dental floss at locations immediately outward of each of said arms of each of said dental flossers, thereby forming at least one coalesced bead in each of said severed ends of said dental floss, where each of said beads has nominal diameter transverse of the axis of said strand that is greater than said nominal breadth of said strand, and
e. releasing said arms of said flossers from said immobilization of step b.

3. A method of manufacturing dental flossers, each comprising a handle and spaced apart arms and a strand of dental floss spanning and engaged to said arms where said dental floss comprises a lubricous plastic which is different from and not chemically bonded to the plastic of said arms, comprising the steps:
a. forming a mold with a plurality of cavities corresponding in shape to said dental flossers, said cavities being oriented similarly and aligned and spaced apart and adapted to receive a strand of dental floss extended through said arm parts of said aligned cavities,
b. injecting liquid plastic into said mold to form said handles with said dental floss molded ‘in situ’ into said arms,
c. cooling said molds and plastic, thereby forming a shot of a plurality of dental flossers with said strand of dental floss connecting said arms of said dental flossers, with a segment of said floss being slack between the adjacent arms of adjacent flossers and said ends extending in opposite directions out of said outermost flossers,
d. immobilizing said arms from moving,
e. engaging the ends of said strand of dental floss and pulling said opposite ends in opposite directions while said arms remain immobilized, such that said dental floss is moved axially through said arms and said slack is removed from between said arms,
f. heating, melting and severing said dental floss at locations immediately adjacent the outside surface of each of said arms of said flossers, thereby forming coalesced beads of the ends of said dental floss extending out of said arms, and
g. releasing said arms of said flossers from said immobilization of step d.

4. A method for removing slack from dental floss in a plurality of molded plastic dental flossers where each of said flossers comprises a handle and arms formed of a first plastic and a strand of dental floss extending with slack between and engaged to said arms, with opposite ends of said strand of dental floss extending outward of said arms, said strand of dental floss having a nominal breadth and formed of a lubricous second plastic which is different from and not chemically bonded to said first plastic, and where said strand of dental floss extends contiguously and axially through the arms of said plurality of dental flossers,
said method for removing slack comprising the steps:
a. immobilizing said arms of said flossers from moving,
b. extending said opposite ends of said floss in opposite directions respectively and securing said ends from moving axially,
c. applying a force transversely to the axis of said floss at locations on said floss as it extends between flossers and where it extends outward from the outermost flossers, while said opposite ends of said floss remain fixed from moving axially, whereby portions of said floss are pulled through said arms until said slack between respective arms of said flossers is removed,
d. heating, melting and severing said dental floss at locations immediately outward of each of said arms, thereby forming at least one coalesced bead in each of said severed ends of said dental floss, where each of said beads has nominal diameter transverse of the axis of said strand that is greater than said nominal breadth/diameter of said strand, and
e. releasing said arms of said flossers from said immobilization of step a.

5. A method for removing slack from dental floss in a plurality of molded plastic dental flossers each of which comprises a handle and arms formed of a first plastic and a strand of dental floss extending with slack between and engaged to said arms, with opposite ends of said strand of dental floss extending outward of said arms, said strand of dental floss having a nominal breadth/diameter and formed of a lubricous second plastic which is different from and not chemically bonded to said first plastic, and where said strand of dental floss extends contiguously through the arms of said plurality of dental flossers,
said method for removing slack comprising the steps:
a. immobilizing said dental flosser handles from moving with said arms thereby located in a first position,
b. pushing said arms of each of said dental flossers to move resiliently from a said first position slightly toward each other to a second position and immobilizing them from further movement laterally,
c. pulling said opposite ends of said strand of dental floss in opposite directions while said arms of said plurality of dental flossers remain immobilized in said second position, such that portions of said strand of dental floss are moved axially through said arms until said slack in said dental floss extending between said arms of said dental flossers respectively is removed,
d. heating, melting and severing said dental floss at locations immediately outward of each of said arms of each of said dental flossers, thereby forming at least one coalesced bead in each of said severed ends of said dental floss, where each of said beads has nominal diameter transverse of the axis of said strand that is greater than said nominal breadth/diameter of said strand, and
e. releasing said arms of said flossers from said immobilization of step b, to resiliently move back toward said first position.

6. A method according to claim 2 further comprising the further step of establishing said plurality of dental flossers in a first plane on a immobilizing fixture, and positioning a further plurality of said dental flossers in a second plane immediately above and upon said first plane of dental flossers, and then applying steps a, b and c to all of said stacked dental flossers.

7. A method according to claim 4 further comprising the further step of establishing said plurality of dental flossers in a first plane on a immobilizing fixture, and positioning a further plurality of said dental flossers in a second plane immediately above and upon said first plane of dental flossers, and then applying steps a-d to all of said stacked dental flossers.

8. A method according to claim 5 further comprising the further step of establishing said plurality of dental flossers in a first plane on a immobilizing fixture, and positioning a further plurality of said dental flossers in a second plane immediately above and upon said first plane of dental flossers, and then applying steps a-d to all of said stacked dental flossers.

9. A method according to claim 1 wherein said step of heating, melting and severing comprises directing a flame onto said dental floss.

10. A method according to claim 1 wherein said strand of dental floss comprises a multi-filament strand and said heating and melting step creates at least one coalesced bead of said multi-filaments.

11. Apparatus operable according to the method of claim 1, for removing slack from dental floss in a molded plastic dental flosser, comprising:
a. a fixture adapted to hold said dental flosser and immobilize said arms from moving,
b. floss-engaging means adapted to pull said opposite ends of said strand of dental floss in opposite directions while said arms remain immobilized, such that portions of said strand of dental floss are moved axially through said arms until said slack in said dental floss extending between said arms is removed, and
c. floss end anchoring means which heats, melts and severs said dental floss at locations immediately outward of each of said arms, thereby forming each of said severed ends of said strand into at least one coalesced bead having nominal breadth transverse of the axis of said strand that is greater than said nominal breadth of said strand.

12. Apparatus operable according to the method of claim 2, for removing slack from dental floss in a plurality molded plastic dental flossers, comprising:
a. a fixture adapted to hold said plurality of dental flossers oriented in spaced apart relationship such that said contiguous strand of dental floss is generally coaxial as it extends through said arms of said dental flossers,
b. said fixture further adapted to immobilize said arms of said dental flossers from moving,
c. pulling means adapted to pull said opposite ends of said strand of dental floss in opposite directions while said arms remain immobilized, such that portions of said strand of dental floss are moved axially through said arms of said dental flossers until said slack in said dental floss extending between said arms in said respective dental flossers is removed, and
d. floss end anchoring means which heats, melts and severs said dental floss at locations immediately outward of each of said arms of each of said dental flossers, thereby forming each of said severed ends of said strand into at least one coalesced bead having nominal breadth transverse of the axis of said strand that is greater than said nominal breadth of said strand.

13. Apparatus according to the method of claim 1, for removing slack from dental floss in a plurality molded plastic dental flossers, comprising:
a. a fixture adapted to hold said plurality of dental flossers oriented in spaced apart relationship,
b. said fixture further adapted to immobilize said arms of said dental flossers from moving,
c. pulling means adapted to pull said opposite ends of said strand of dental floss in opposite directions while said arms remain immobilized, such that portions of said strand of dental floss are moved axially through said arms of said dental flossers until said slack in said dental floss extending between said arms in said respective dental flossers is removed, and
d. floss end anchoring means which heats, melts and severs said dental floss at locations immediately outward of each of said arms of each of said dental flossers, thereby forming each of said severed ends of said strand into at least one coalesced bead having nominal breadth transverse of the axis of said strand that is greater than said nominal breadth of said strand.

14. Apparatus operable according to the method of claim 4, for removing slack from dental floss in a plurality of molded plastic dental flossers, comprising:
a. a fixture adapted to hold said plurality of dental flossers and to immobilize said arms from moving,
b. floss and engagement means extending said opposite ends of said dental floss in opposite directions respectively and securing said ends from moving axially,
c. floss pusher means adapted to apply a force perpendicularly to the axis of said strand at locations on said floss as it extends between flossers and where it extends outward from the outermost flossers, while said opposite ends of said strand remain fixed from moving axially, whereby portions of said strand are pulled through said arms until said slack between respective arms of said flossers is removed, and
d. floss end anchoring means which heats, melts and severs said dental floss at locations immediately outward of each of said arms, thereby forming each of said severed ends of said strand into at least one coalesced bead having nominal breadth transverse of the axis of said strand that is greater than said nominal breadth of said strand.

15. Apparatus operable according to the method of claim 5, for removing slack from dental floss in a plurality of molded plastic dental flossers, comprising:
a. a fixture adapted to hold said plurality of dental flossers and to immobilize said dental flosser handles from moving,
b. means pushing said arms of each of said dental flossers to move resiliently slightly toward each other and to immobilize them from further movement laterally,
c. means pulling said opposite ends of said strand of dental floss in opposite directions while said arms of said plurality of dental flossers remain immobilized, such that portions of said strand of dental floss are moved axially through said arms until said slack in said dental floss extending between said arms of said dental flossers respectively is removed, and
d. floss end anchoring means which heats, melts and severs said dental floss at locations immediately outward of each of said arms of each of said dental flossers, thereby forming each of said severed ends of said strand into at least one coalesced bead having nominal diameter transverse of the axis of said strand that is greater than said nominal breadth/diameter of said strand.

16. Apparatus according to claim 11, where said fixture is adapted to hold said plurality of dental flossers in a first plane on said immobilizing fixture, and to hold a further plurality of said dental flossers in a second plane immediately adjacent said first plane of dental flossers, said fixture further adapted to remove said slack from all of said dental flossers held by said fixture.

17. Apparatus according to claim 11 wherein said floss-end anchoring means comprises a flame directed onto said dental floss.

18. Apparatus according to claim 11 wherein said strand of dental floss is a multi-filament strand, and said heating and melting step creates at least one coalesced bead of said multi-filaments.
